(19) United States
(12) Patent Application Publication
(10) Pub. No.: US 2002/0111972 A1
(43) Pub. Date: Aug. 15, 2002

(54) Virtual access

(75) Inventors: Gerard D. Lynch, Newburyport, MA (US); Chappell Floyd, Malden, MA (US); Dana Bruce Berenson, Bradford, MA (US); Andrew Shay Woodard, Raleigh, NC (US); Richard Joel Castello, Methuen, MA (US); Marcus Vinicius A. Goncalves, Hopkinton, MA (US)

Correspondence Address: LACASSE & ASSOCIATES, LLC, 1725 DUKE STREET, SUITE 650, ALEXANDRIA, VA, 22314, US

(73) Assignee: Virtual access networks. INC.

(21) Appl. No.: 09/736,223

(22) Filed: Dec. 15, 2000

(51) Int. Cl. G06F 3/14; G06F 17/24

(52) U.S. Cl. 707/523; 707/517

(57) ABSTRACT

A first group of application settings, files and other data, of a first specific format, is converted and transferred to a second related format with respect to a receiving computer-based device, so that the receiving computer-based device will have a substantially similar operating environment to that associated with the first group. First, a communication link is established between a first computer-based device and the web site. Next, the first computer-based device is scanned, via the web site, to determine the information contained on the first computer-based device. The user then selects which of the scanned information is to be uploaded from the first computer-based device onto the web site for temporary storage. Finally, the selected information is transferred from the first computer-based device onto the web site for temporary storage. Once retrieval of the temporarily stored information is desired, the user establishes a communication link between a second computer-based device and the web site. The second computer-based device is scanned, via the web site, to determine the information contained on the second computer-based device. The temporarily stored information, from the first computer-based device on the web site, is then displayed to the user and the user selects which of this temporary information, from the first computer-based device, is to be downloaded from the web site onto the second computer-based device. The selected information is finally formatted by a format management module and downloaded from the website onto the second computer-based device.

### CROSS-REFERENCE TO OTHER APPLICATIONS

The present application claims the benefit of provisional patent application “System for Transporting Application Settings, Files and Other Data from One Computer to Another Computer”, Ser. No. 75/836,301, filed Mar. 29, 2000.

### BACKGROUND OF THE INVENTION

1. Field of Invention

The present invention generally relates to virtual access across communication systems. More specifically, the present invention relates to a format management method and system for transferring and converting a first group of application settings, files and other data, of a first specific format, to a second related format with respect to a receiving computer-based device, so that the receiving computer-based device will have a substantially similar operating environment to that associated with the first group.

2. Background of the Invention

Computer users typically arrange their personal or work computer to suit their preferences. For example, on a personal computer, desktop settings (such as the background design on the monitor, e.g., the “wallpaper”), automatic start-up commands, Internet settings, e-mail server settings, or e-mail address book settings are frequently customized. Over time, individuals will normally store certain software applications and data on their PCs. These applications are typically customized to suit the individual user's particular preferences. For instance, with regard to a word processing application, the user may specify a preferred default font, a custom page layout, customized spell-checking dictionaries, and easy access to frequently retrieved files.

One major challenge associated with configuring a new or already existing computer-based device is to provide users with a computing environment that they have a “feel” for or a computing environment that they are familiar with. In one scenario, users may be interested in a new computer-based device's increased speed or storage capacity, but they are unable to match the “feel” or “computing environment” of his current computer-based device.

In a second scenario, users who have just acquired a computer-based device such as a cellular phone, or more specifically a web-enabled phone, often face the dilemma of having to re-enter their address book entries and their e-mail settings in the new electronic mail system (resident in their cellular phone) just to create the same “feel” or “computing environment” of the electronic mail system residing in their computer-based device, such as a personal computer (PC), that is located at home or office. Often users are unable to remember all the details associated with their e-mail settings and address book, and thus have to resort to sitting in front of their personal computer at home or office, reading the entries corresponding to settings and address books, and entering them manually into their cellular phones.

Another common feature available today in portable computer-based devices is the ability to browse the World Wide Web (WWW) using such a device. But, again users are unable to have the same “feel” or “computing environment” in such a device because users have to go through and painstakingly enter all the associated browser settings and bookmarks, and thus have to endure both the time and effort to customize the new portable computer-based device that they purchase. No method exists to easily enable the user to selectively direct transference of the “look and feel” or content of existing devices to new or other devices which may differ in format, form factor, capacity, platform, operating system or function. It would be useful to carry the user's configuration from device to device without requiring the user to reconfigure each time (i.e., customizing hardware and software settings, reloading software and files, etc.)

Thus, when a user purchases a new computer-based device (as a stand alone or a replacement device), it can take many hours to reconfigure the device so that the operating environment is similar to the environment that is familiar to the user. For example, most software applications are customized according to each individual user's personal preferences. By simply reloading the original software program discs on the replacement computer-based device, the user will lose all of his or her personal preferences. Thus, the user must reconfigure all the applications so they are customized to his or her liking. Not only can this process be time consuming, but it can also be technically difficult for those users with moderate computer-based device experience. In addition, older software applications maybe incompatible with the newer computer-based device's operating system, or may require upgrades, and this may further complicate the transfer process.

Additional problems arise when information or data, in a format specific to a first computer-based device, is transferred on to a second computer-based device associated with a different format. For example, if a user wants to transfer information from a personal computer on to a mobile computer-based device such as a cellular telephone, conflicts arise because of different data formats associated with each of the said devices. The same is true if one wants to transfer information from a mobile compute-based device such as a cellular telephone to a personal computer.

Another scenario in which users are affected by the “feel” and “computing environment” is remote access, wherein a user can access remotely their e-mail or browse the web via various applications located in a specialized booth, such as a kiosk. But, once again users are unable to personalize such a communication because of the inability to access the settings involving the browser and the address book of the user. Even in the instance where users are able to copy (onto a disk or CD-ROM) the necessary files associated with browser settings and address book entries, the user still has to deal with formatting the data, so it is compatible with the format associated with the kiosk.

Therefore, what is needed is a format management method and system for transferring and converting application settings, files and other data, of a first specific format, from a first computer-based device, to a second specific format with respect to a second computer-based device, so that the second computer-based device will have a substantially similar operating environment as the first computer-based device. Whatever the precise merits, features and advantages of the prior art, it fails to achieve or fulfill the purposes of the present invention.

### SUMMARY OF THE INVENTION

The present invention provides for a format management method and system for transferring and converting a first group of application settings, files and other data, of a first specific format, to a second related format with respect to a receiving computer-based device, so that the receiving computer-based device will have a substantially similar operating environment to that associated with the first group.

Furthermore, the present invention provides for streamlining the transportation of the desired application settings, files and other data, of a first specific format, from a first computer device to a second specific format with respect to a second computer-based device, without requiring the user to install or use any cabling, other than a conventional network connection. The network connection comprises any of (but not limited to): wide area networks (WANs), local area networks (LANs), wireless networks, Internet, or any network that uses the HTTP protocol.

In one embodiment, the present invention provides for a method and system in which the user of the method and system is readily able to select the desired applications settings, files and other data, of a first format, that are to be transferred from the original, first computer-based device with a first data format, to a temporary storage site. Also, the system facilitates selection of the files, settings and other personal data to be downloaded, from the temporary storage site onto a second computer-based device, wherein a format management system converts the desired applications settings, files and other data from the first said format to a second format that is compatible with the second computer-based device.

In yet another embodiment, the present invention utilizes the HTTP protocol over the Internet, WWW, LANs or other communications networks to facilitate and streamline the process of transferring the application settings, files, data, and other personal settings, of a first format associated with the first computer-based device to the temporary storage site and converting and transferring these application settings, files, data, and other personal settings to match a format associated with a second computer-based device, with little or no technical know how related to the transfer process. The user can simply follow easy and thorough directions supplied by the GUI (e.g., web page interface) operated as part of this invention.

Furthermore, the present invention provides for a system that allows computer-based devices, employing a variety of different operating systems, to interact with the website of the server system.

The present invention also provide a system which allows computer-based devices, employing a variety of different communications standards, to interact with the website of the server system.

Also described is a streamlined transportation of desired application settings, files and other personal data in a consumer, enterprise or industrial environment, employing computer-based devices with a variety of different hardware and software formats.

The present invention facilitates a quick and easy format management method and a system for transferring and converting application settings, files and other data, of a first specific format, from a first computer-based device, to a format compatible with respect to a web-enabled phone, so that the web-enabled phone will have a substantially similar operating environment as the first computer-based device. The transfer is accomplished over any of, or a combination of, the following (but not limited to) networks: WANs, LANs, networks using the HTTP protocol, Internet, or a wireless network.

In one embodiment, the present invention streamlines the transportation of the desired application settings, files and other personal data using a combined Javao and markup language based solution. The markup language used is any of (but not limited to) or a combination of the following: SGML, HTML, or XML.

These and other advantages of the present invention will become more apparent after consideration of the following description and the accompanying drawings.

### BRIEF DESCRIPTION OF THE DRAWINGS

The invention will now be described, by way of example, with reference to the accompanying drawings in which:

FIG. 1 is a diagrammatic illustration of the architecture of the present invention in an Internet embodiment.

FIG. 2 is a diagrammatic illustration of the various components comprising the website server according to the present invention.

FIG. 3 is a diagrammatic illustration including the client ATL DLL according to the present invention.

FIG. 4 illustrates a general overview of the present invention's system for accessing a profile contained in a directive file via various computer-based devices.

FIG. 5 illustrates a brief overview of the present invention's method for converting a directive file associated with a first computer-based device to a format compatible with a second computer-based device, and delivering the converted profile, also contained in a directive file, to the second computer based-device running a different operating environment.

FIG. 6 illustrates the format management module utilized by the present invention.

FIG. 7 illustrates a flowchart of the method associated with the upload scenario as shown in FIG. 4.

FIG. 8 illustrates the system associated with the upload scenario of the present invention.

FIG. 9 illustrates the flowchart of the method associated with the download scenario as shown in FIG. 4.

FIG. 10 illustrates the system associated with the download scenario of the present invention.

FIG. 11 illustrates the conversion process for providing data in a WML format.

FIG. 12 illustrates another embodiment of the present invention in which a WAP phone or optionally a Web browser accesses Microsoft Outlooks contacts, stored in a BDS.

FIG. 13 illustrates the present invention's implementation in a kiosk scenario.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Throughout the following descriptions, figures and claims, the terms PC, computer and computer-based device may be interchanged without departing from the scope of the present invention. In addition, the term “van” is used when referring to the collected settings, files and personal data.

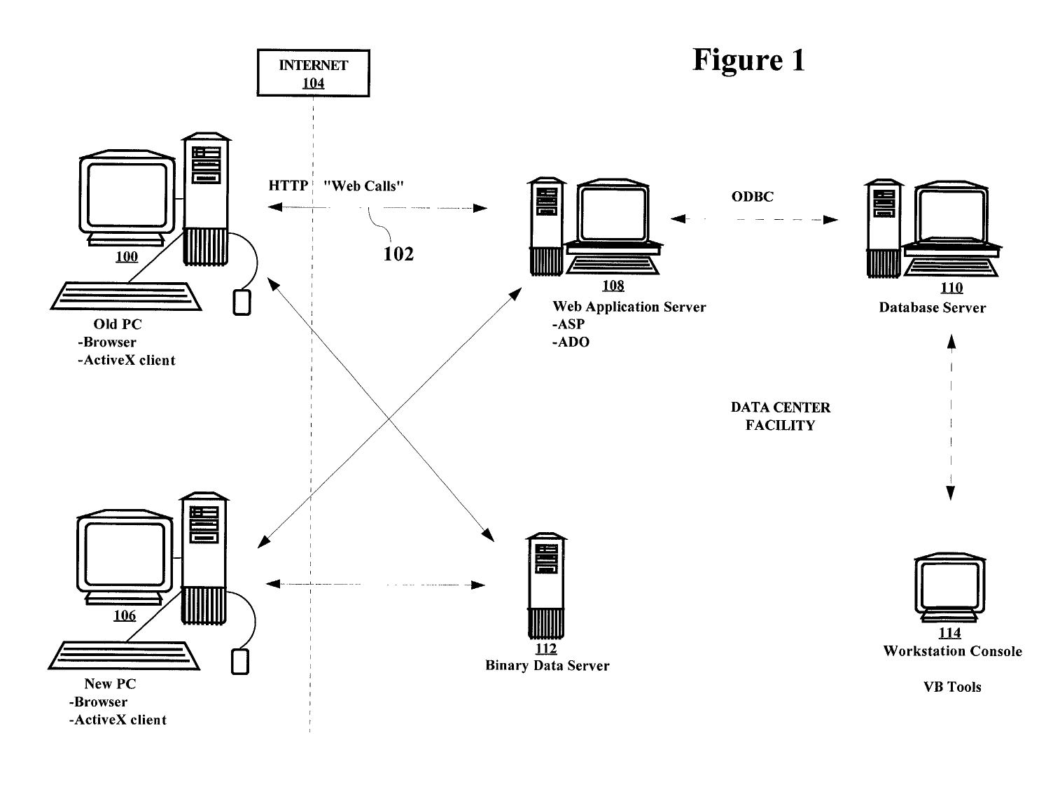

FIGS. 1-3, and their corresponding discussion provide a general discussion of the environment to implement the present invention. A complete discussion may be found in co-pending application entitled, “System for Transporting Application Settings, Files and Other Data from One Computer-based Device to Another Computer-based Device”, hereby incorporated by reference.

As shown in FIG. 1, a first PC, generally designated as 100, has an internal or external modem (not shown) which is electronically coupled by a conventional connection 102 (wired or wireless) to a communication system, e.g., the Internet (preferred for consumer environment), some other desired local area network (LAN-preferred for enterprise environment), wide area network (WAN), virtual network, Intranet, wireless web, or equivalents, generally designated as 104. PC 100 is also electrically coupled to a display device, e.g., a monitor, by conventional cabling, an input device, e.g., a keyboard, by conventional cabling, and to a mouse. As with typical computer-based devices, PC 100 also has a plurality of internal components (not separately designated or shown) such as a central processing unit (CPU), some ROM, some RAM, a hard disc drive, an internal computer software. The PC 100, is typically loaded with conventional software, some of which was initially installed on the computer-based device at the time of purchase, while a remainder of the computer software may have been periodically installed by the user in a conventional manner. It is to be appreciated that a variety of other PCs 106, having similar components, may also be simultaneously connected to the website of the server system 108.

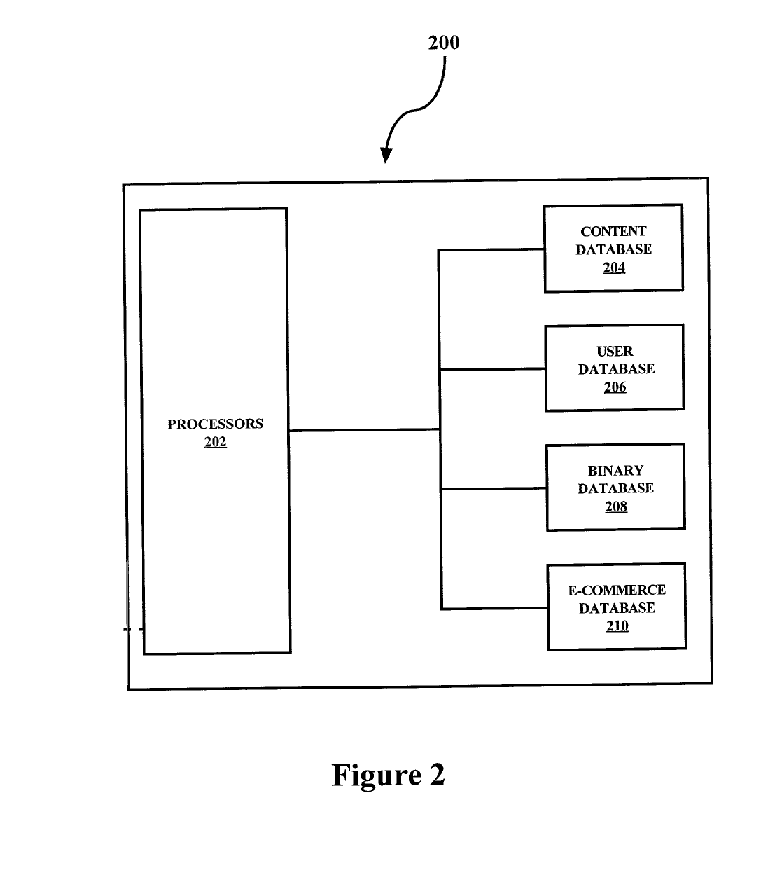

As can be seen in FIG. 2, a block diagram of the server system, showing the components 200 that facilitate allowing a user to transfer application settings, files and other data, of a first format, from a first computer-based device onto the web site for later retrieval by another computer-based device, with a similar or different operating environment format is shown. The website of the server system 200 comprises conventional processors 202 which are electrically coupled, in a conventional manner, to a plurality of databases, such as a content database 204, a user database 206, a binary database 208, and an e-commerce database 210.

Processors 202 comprise and operate the programmed routines that run on the first computer-based device 100 and the second computer-based device 106 to scan those computer-based devices and detect the software applications, application settings, files and hardware data, and any other information necessary for a successful transfer of desired information. After scanning both the first and second computer-based devices involved in the transfer of information (as discussed below in further detail), the processors then compare and correlate the relevant data from the first computer-based device 100 with that of the second computer-based device 106 to determine what application settings, files and other data are available for transfer. The processors 202 facilitate displaying of this information to the user and ultimately facilitate the transfer of the application settings, files and other data that the user selects to be transferred from the first computer-based device 100 into storage and later onto the second computer-based device 106. A format management system of the present invention is associated with the processors to make sure that the data from computer-based device 100 is transferred onto second computer-based device 106 in a format compatible with said second computer-based device 106.

Server system 200 also comprises one or more individual databases to enable the storage and retrieval of user data, web site content data, internal use data, data regarding current software application versions, and other miscellaneous data. Processors 202 are able to interact with each database to retrieve data necessary to carry out the desired routines. Processors 202 are also able to interact with each of the individual databases in order to store data within those databases.

Server system 200 contains content database 204 for the purpose of storing any data that is displayed to the user, e.g., GUIs, web site pages, advertisements, offers, etc., as well as any data related to applications and application settings obtained from the manufacturers of the respective software applications. This database will be updated frequently to continually contain the most current data regarding software applications and their application settings.

Server system 200 also contains user database 206 for the purpose of storing data related to each individual user's computer-based device, personal profile, applications, account number, login password to the system server, etc. Processors 202 will utilize this user data to facilitate the transfer process. The user data can also be used to trigger the server system to display to the user, via the web site, advertisements and offers targeted to the user's particular profile, as discussed below in further detail.

Furthermore, server system 200 also contains Binary Database 208 t o store binary files, e.g., documents, e-mails, address books, etc. uploaded from first computer 100. The user selects specific data stored for download to second computer 106.

Server system 200 also contains e-commerce database 210 to store data related to on-line purchases by the user with relation to the transfer process. For instance, during the transfer process, the server system may have detected and informed the user that a software application on first computer-based device 100 has since been upgraded. In turn, the user may decide to purchase, through the server system, the most recent upgraded version of the software for the second computer-based device. All the data necessary for this purchase, e.g. credit card information, billing information, etc., can be handled and stored in this database.

A general description of the software module—client ATL DLL, or CAD, is given below, but a complete discussion of the CAD may be found in co-pending application entitled, “System and Method for Determining and Transporting Application Settings, Files and Other Data Between Computer-Based Devices”, hereby incorporated by reference.

The CAD is the module of the system the runs on the end user's old and new PC. Responsibilities here would include scanning of the registry, interaction with the user, and communication with a Web Application Server using “web calls.” The client would also upload and download binary data files like bitmaps, Word docs, etc. from a Binary Data Server. Key components to the client are:

Active Template Library (ATL) based C++ ActiveX control hosted in IE® browser

Directive processor that follows the actions defined in directive files

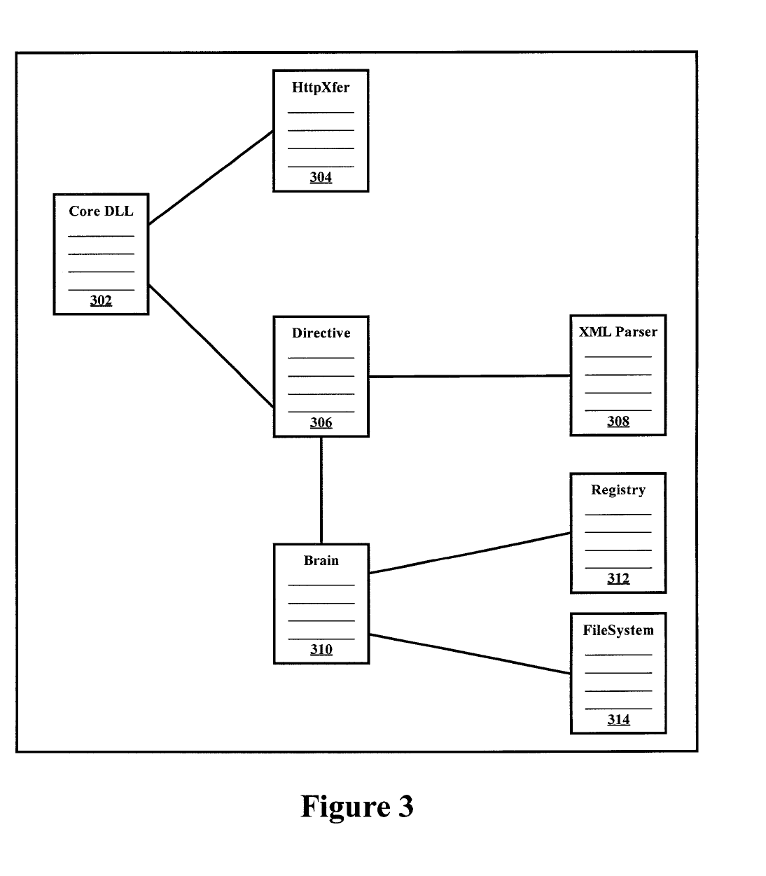

XML parser that encodes and decodes the directive file format The client ATL DLL CAD is a simple object-oriented system as shown in the UML diagram of FIG. 3:

The core DLL 302 maintains the functionality inherited from the ATL foundation classes to provide the ActiveX control support required for the DLL to be hosted by IE 4/5 browsers.

HttpXfer 304: This is an object that encapsulates the asynchronous file transmissions that occur to/from the website Web 108 and Binary Data Servers 112.

Directive 306: The Directive object responds to the actions that come from the tags that the XML Parser decodes from directive files.

XML Parser 308: This is responsible for decoding directive files.

Brain 310: The Brain (processor) carriers out the actions it is dispatched from the Directive object.

Registry 312 and FileSystem 314: These objects are used by the Brain to access the settings in the registry and files in the filesystem.

The invention will be described in a preferred embodiment of transference from an old PC to a different PC, personal digital assistant (PDA), telephones, etc., however, pre-stored vans in the BDS or artificially created vans may be substituted without departing from the scope of the present invention.

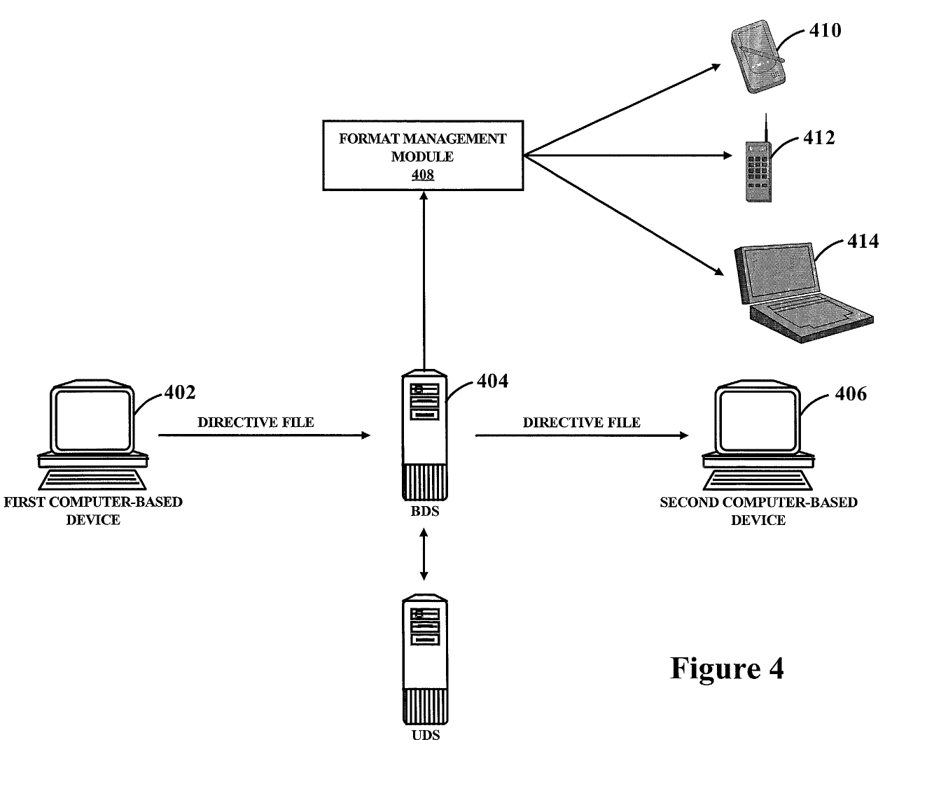

FIG. 4 illustrates a general overview of the present invention's system for accessing a profile contained in a directive file via various computer-based devices. A profile is uploaded from first computer-based device 402 and stored onto BDS 404 in a markup language based directive file. Next, second computer-based device 406 (having the same operating platform as the first computer-based device) is able to access the directive file on BDS 404, if a user wants to configure a second computer-based device 406 to have the same “feel” as first computer-based device 402. For example, if a profile containing the application settings, files, and other data is transferred from the first computer-based device running Windows 98® as its operating system, to the second computer-based device, also running Windows 98® and having identical applications, the directive file is transferred unchanged due to underlying similarity in operating systems. In the event the second computer-based device does not have the same operating platform as the first device, a conversion of the directive file to a format that is compatible with second computer-based device(s) 410, 412, 416 is necessary and is done via the present invention's format management module 408. For example, a profile that is related to a first PC running Windows 95® needs to be converted to a similar profile that is compatible with a laptop running Windows 98®, before it can be transferred and installed on the laptop.

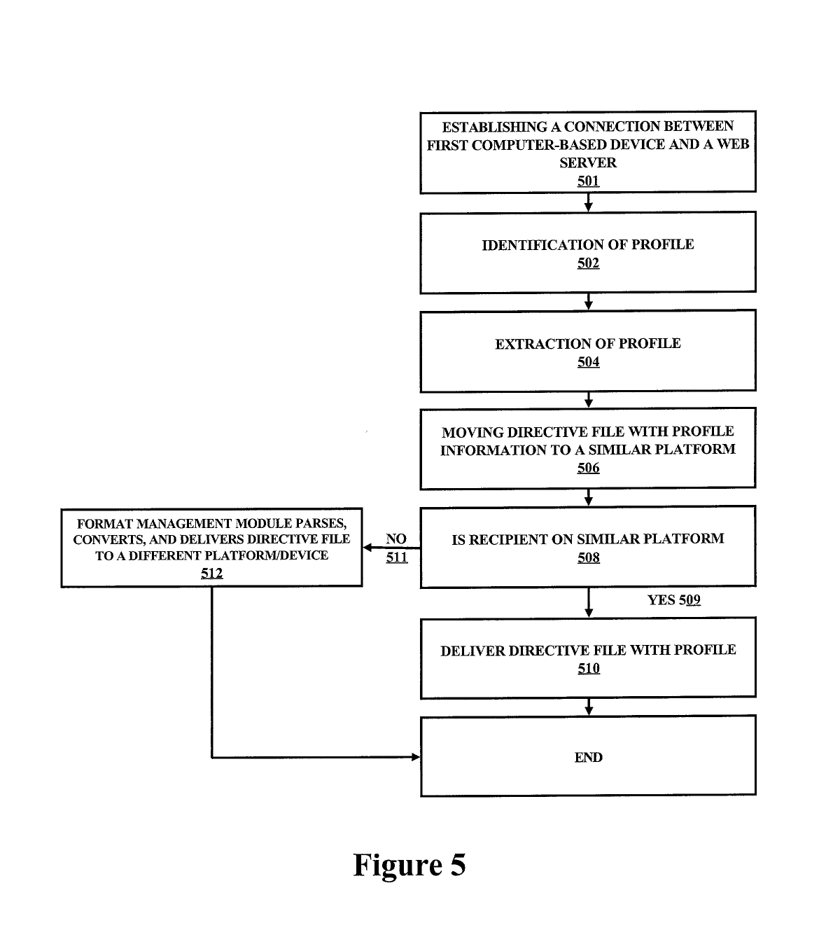

FIG. 5 illustrates a brief overview of the present invention's method for converting a directive file associated with a first computer-based device to a format compatible with a second computer-based device, and delivering the converted profile, also contained in a directive file, to the second computer based-device running a different operating environment. First, a connection is established 501 between the first computer-based device and a web server. A profile to be uploaded from a first computer-based device is identified 502, and the identified profile is extracted 504 and transported 506 onto a storage server (e.g., binary database server). Next, a communication link is established between the second computer-based device and web server and a decision is made 508, if the recipient (second computer-based device) belongs to the same platform (or similar system/data format) as first computer-based device. If both share a similar platform (or similar system/data format) 509, the storage server downloads the profile onto the second computer-based device 510. In the event that the formats do not match 511, a format management model is invoked and the profile (in the XML directive file) stored in the storage server is parsed, converted, and delivered in a format compatible with the second computer-based device 512.

The format management module used in the preferred embodiment is Cocoon® (part of Apache's open source). Cocoon is a java publishing framework that relies on the document object model (DOM), extended markup language (XML), and extended stylesheet language (XSL) to provide network content or more specifically web content. The Cocoon framework changes the way information on a network is created, rendered, and served. Cocoon allows for a separation of these three layers, allowing these layers to be independently designed, created, and managed, thereby playing an important role in format management. A brief description of DOM, XML, and XSL is given below:

DOM, short for Document Object Model, represents the specification for how objects in a Web page (text, images, headers, links, etc.) are represented. The DOM defines what attributes are associated with each object, and how the objects and attributes can be manipulated. Dynamic HTML (DHTML) relies on the DOM to dynamically change the appearance of Web pages after they have been downloaded to a user's browser.

XML, short for extensible markup language, represents a specification developed by the World Wide Web Consortium or W3C (www.w3c.org). XML is a pared-down version of SGML, designed especially for Web documents. It allows designers to create their own customized tags, enabling the definition, transmission, validation, and interpretation of data between applications and between organizations.

XSL or extensible style language is a specification for separating style from content when creating HTML or XML pages. The specifications work much like templates, allowing designers to apply single style documents to multiple pages. XSL is the second style specification to be offered by the W3C. The first, called cascading style sheets (CSS), is similar to XSL but does not include two major XSL's innovations—allowing developers to dictate the way Web pages are printed, and specifications alloigoeo transfer XML documents across different applications. Extensible Style Language Transformation (XSLT) is the language used in XSL style sheets to transform XML documents into other XML documents. An XSL processor reads the XML document and follows the instructions in the XSL style sheet, then it outputs a new XML document or XML-document fragment.

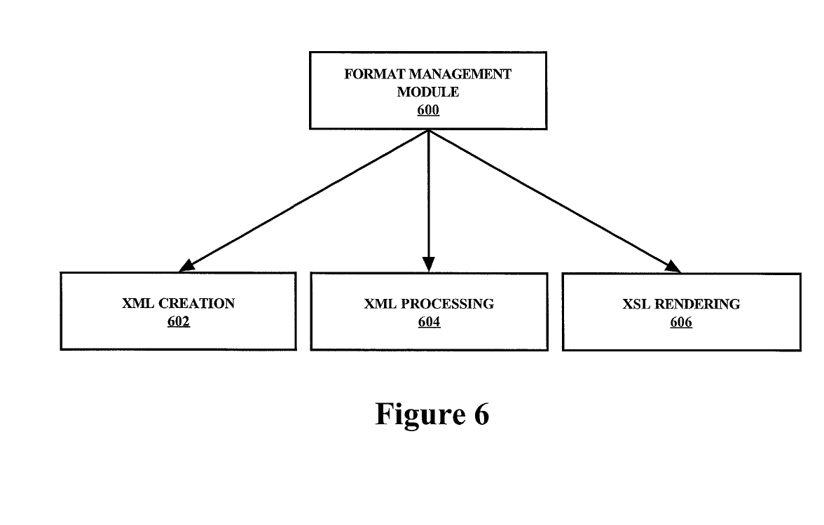

Referring to FIG. 6, format management model 600 (such as Cocoon) comprises three layers: creation 602, processing 604, and rendering 606. XML creation step 602 involves the creation of an XML file either automatically by a piece of software or manually by the content owners. This is optionally accomplished using a particular chosen “DTD” or tagset. XML processing step 604 involves processing the requested XML file, and applying the logic contained in its logicsheet(s). It should be noted that in this step, the logic is separated from the content file. Lastly XSL rendering step 606 involves rendering using an XSL stylesheet and formatting to the specified resource type (HTML, PDF, XML, WML, XHTML, etc.) Thus, the Cocoon model creates an XML file, processes and evaluates the logic associated with the XML file, and lastly formats it into the right output format for client use.

The web publishing model utilized by the present invention is based on the Apache™ XML project, which in turn is made up of a number of sub-projects that work together in a modular fashion as a complete XML-based web publishing solution. Advantages associated with this solution include easy re-purposing of data, complete separation of content and formatting, and fast and reliable translation to multiple popular content platforms. Some of the above-mentioned sub-projects that work together in the present invention's system are described below:

| | |
|---|---|
| Xerces: | Xerces provides for a highly modular and configurable XML parser |
| | implementing the W3C DOM standard in Java ®, C++, Peri, and component |
| | object model (COM) bindings. |
| Xalan: | Xalan implements the W3C XSLT and XPath recommendations to provide |
| | for a robust and feature-rich XSLT stylesheet processing. |
| Cocoon: | Cocoon, as described above, is a framework for XML web publishing. |
| FOP: | FOP is a java-based print formatter driven by XSL formatting objects, like |
| | PDF and postscript. |
| Xang: | Xang is used to integrate disparate data sources, based on standards such as |
| | HTML, XML, XSL, DOM, and JavaScript, using cross-platform web |
| | applications. |
| SOAP: | Simple object access protocol (SOAP) is a protocol for transmitting, sending, |
| | or packaging data. |

One major benefit associated with using Cocoon in conjunction with the present invention is its ability to separate the content of a file from the format of a file. A few of the functions associated with Cocoon include:

Handling requests for pages.

Determining which platforms are requesting the pages.

Calling Xerces to parse the XML content of a file.

Calling Xalan to apply the proper stylesheet for the platform in order to output the XML data in the proper format (HTML, WML, etc).

Thus, in the system of the present invention, by utilizing Cocoon, the XML directive files are created first, and next, the web server 108 processes these directive files to evaluate the logic behind them, and last, an XSL stylesheet is used to render these directive files so that the format is compatible with the second computer-based device 106.

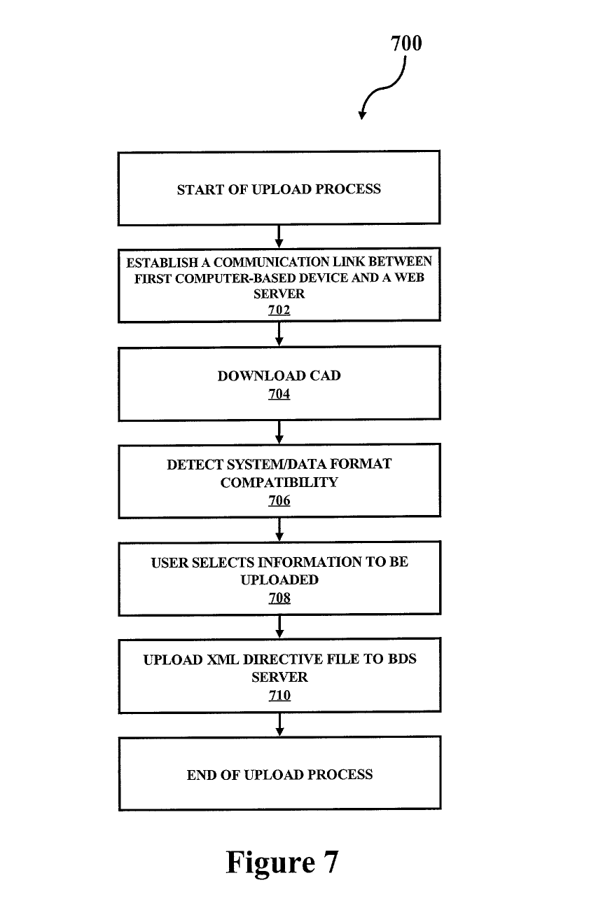

Returning to the discussion of the embodiment described in FIG. 4, wherein information is transferred from a first computer-based device 402 to any of the following second computer-based devices 410, 412, or 414. FIG. 7 illustrates the flowchart of the method 700 associated with the upload scenario. First, a communication link is established 702 between first computer-based device 402 and web server 108. Next, if all the necessary components (e.g., Java Component is available and is turned on) are found on first computer-based device 402, a CAD is downloaded 704 onto the first computer-based device 402. Next, the system detects the system and data compatibility format 706, so it knows what format to store the data to be transported. The user then selects information (comprising any of the following: application settings, files, and other data) 708 to be uploaded onto a server. Last, the CAD then uploads an XML directive file 710 with the selected information onto the binary data server.

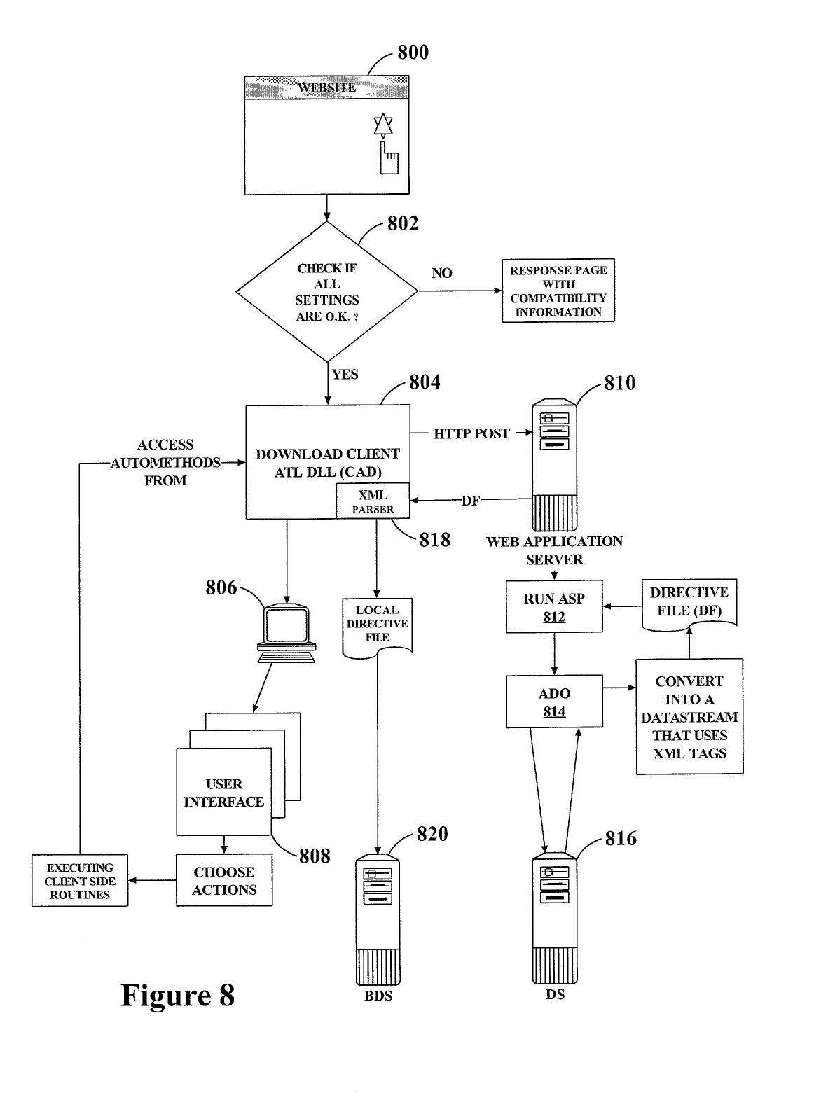

FIG. 8 illustrates a detailed description of the system associated with the present invention. First, a software module (CAD 804) is downloaded onto first computer-based device 806. This can be accomplished in a variety of ways. In one embodiment, a website is accessed by consumers who download a software module (CAD 804) by clicking on an icon on the webpage 800. In a further embodiment, check 802 is performed to see if the settings on first computer-based device 806 make it compatible to download the software module (CAD 804), and upon establishment of compatibility, CAD 804 is downloaded. In the event of incompatibility, a response page is presented to the consumer indicating what needs to be upgraded in first computer-based device 806 for successful execution of the software module (CAD 804).

After CAD 804 is successfully downloaded onto the first computer-based device, user interface 808 is generated to get input from the user. In one embodiment, user interface 808 is a set of HTML web pages. After reviewing user interface 808, users decide which files, settings, or other data need to be uploaded to a server for storage. Next, an instruction (e.g., a HTTP POST command) is sent from CAD 802 to web application server 810 regarding information on the location of the files, settings, and other data to be uploaded. Web application server 810 then runs an Active Server Page (ASP) 812 that uses Active Data Object (ADO) 814 to query database server 816. Next, database server 816 returns a resultant set in ADO 814 that contains information regarding the location of files, settings, and other data to be uploaded. ASP 812 then steps through every record in ADO 814 and converts it into a data stream that uses XML tags. This XML format of data with tags specific to the present invention is called a directive file. The directive file is then passed on to XML parser 818 in CAD 804 where it is parsed and relevant files, settings, or other data are extracted. Then, the extracted data is accumulated in yet another directive file called the local directive file. Lastly, the local directive file is uploaded to binary data server 820 using an instruction such as a HTTP POST command.

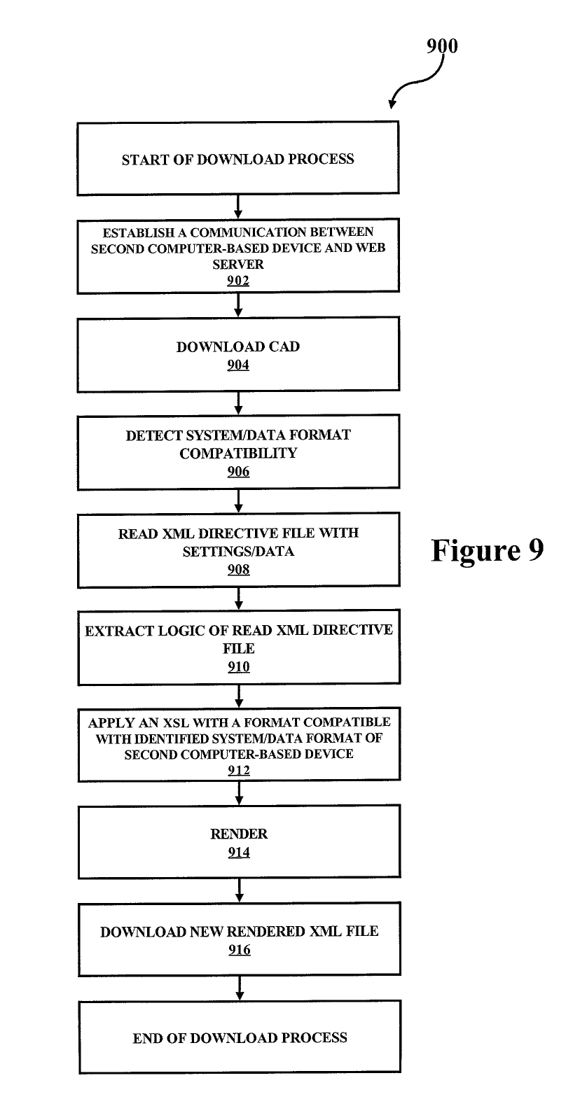

FIG. 9 illustrates the flowchart of the method 900 associated with the download scenario as shown in FIG. 4. First, like the upload scenario, a communication link is established 902 and after detection of all necessary components, a CAD is downloaded 904 onto the second computer-based devices.(410, 412, 414). Next, the system detects the data and system compatibility formats 906, to determine the parameters and limitations of the format for the downloaded. Furthermore, the stored XML directive file is read 908 and processed to extract the logic 910 associated with said XML file. Next, an XSL stylesheet 912, with a format compatible with the second computer-based device is applied and rendered 914 with respect to the end client's resource type format. Lastly, the downloaded rendered XML directive file is parsed and the new settings take effect 916.

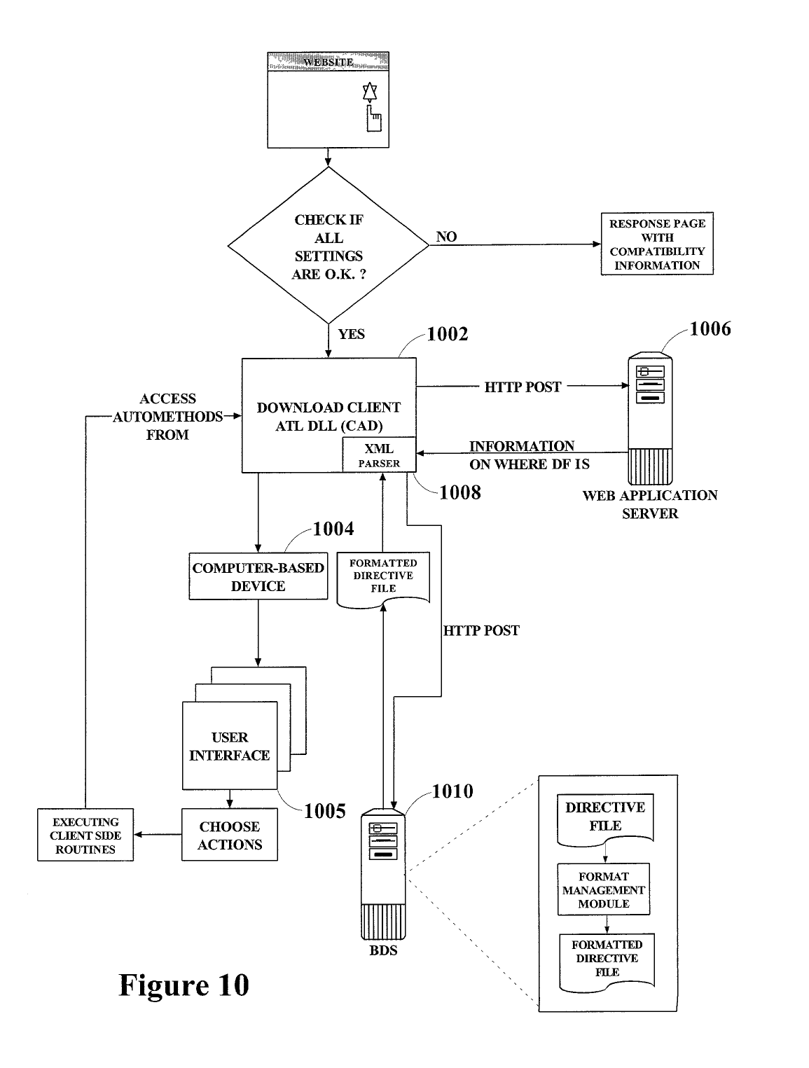

The system associated with the method of FIG. 9 is described in FIG. 10. First, software module (CAD) 1002, compatible with second computer based device 1004, is downloaded onto said device 1004 via a network (such as the Internet, wireless network, networks based on HTTP protocol, or a combination of such networks). In one embodiment, in the event of incompatibility, the system provides second computer-based device 1004 with a response page with compatibility information. Next, CAD 1002 identifies the file and data format associated with second computer-based device 1004. A user then requests various files, settings, and other data via interface 1005 generated by the CAD 1002. CAD 1002 then sends an instruction (such as a HTTP POST command) to web application server 1006 requesting information regarding the location of a directive file which contains information requested by the user regarding the settings, files, and other data that need to be downloaded. Web application server 1006 then passes this information onto parser 1008 located in CAD 1002. Next, CAD 1002 sends an instruction (such as a HTTP POST command) to the binary database server (BDS) 1010 requesting said directive file in a format compatible with computer-based device 1004. BDS1010 extracts the corresponding directive file and uses a format management module to render the directive file in the format compatible with the second computer-based device 1004. Lastly, BDS 1010 returns the requested directive file to device 1004. Once requesting computer-based device 1004 receives the directive file (containing the application settings, files, and other data), software module (CAD) 1002 parses the directive file (via XML parser 1008), installs and updates necessary settings, files, and other data in their respective locations such that the receiving computer-based device's operating environment is similar to that of the first computer-based device. In a further embodiment, an option is provided in the CAD 1002 such that users can revert back to the operating environment previously held by the receiving computer-based device if they are not satisfied with the newly installed profile.

It should be noted that although in all the embodiments described above the directive file that contains the profile data is first uploaded onto the BDS, one skilled in the art can extend the idea to have generic profiles stored in the BDS. Thus, users who have just purchased a computer-based device can access the BDS and download a profile that best fits their needs. For example, a downloaded best-fit profile is based on the user's demographics.

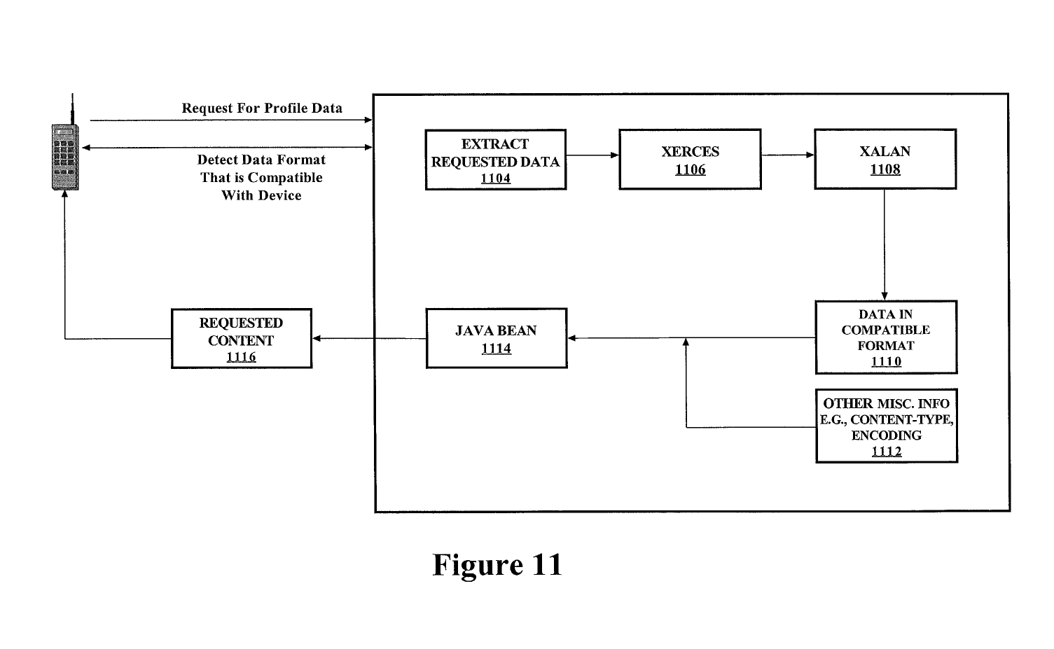

FIG. 11 illustrates in further detail the format management system of FIG. 11 which is located on the BDS. When a request for settings, files, or other data is made by a user via a computer-based device, such as a web-enabled phone, a process in the BDS checks the configuration file and detects WAP 1102 needs content in wireless markup language (WML) format. Next, requested data is extracted 1104 and passed on to Xerces 1106, an XML parser, which in turn feeds the output data to Xalan 1108, the XSLT stylesheet processor, which outputs the requested data in the necessary format (in this case: WML format) 1110. Finally, the requested data (in WML format) is supplied to JavaBean 1114 along with other information 1112, like content-type and encoding, and the JavaBean serves the content 1116 to the requestor (WAP phone) 1102. Once WAP phone 1102 receives the requested content (containing the application settings, files, and other data), it installs and updates necessary settings, files, and other data in their respective locations such that the WAP phone's operating environment is similar to the environment associated with the received profile. In a further embodiment, an option is provided in the WAP phone 1102 such that users can revert back to the operating environment previously held by the phone if they are not satisfied with the newly installed profile. In another further embodiment, the format management system caches the content for faster access for future requests and the content is applied to the telephone's environment. In other words the settings such as bookmarks, addressbook entries, and addressbook settings are now updated or modified.

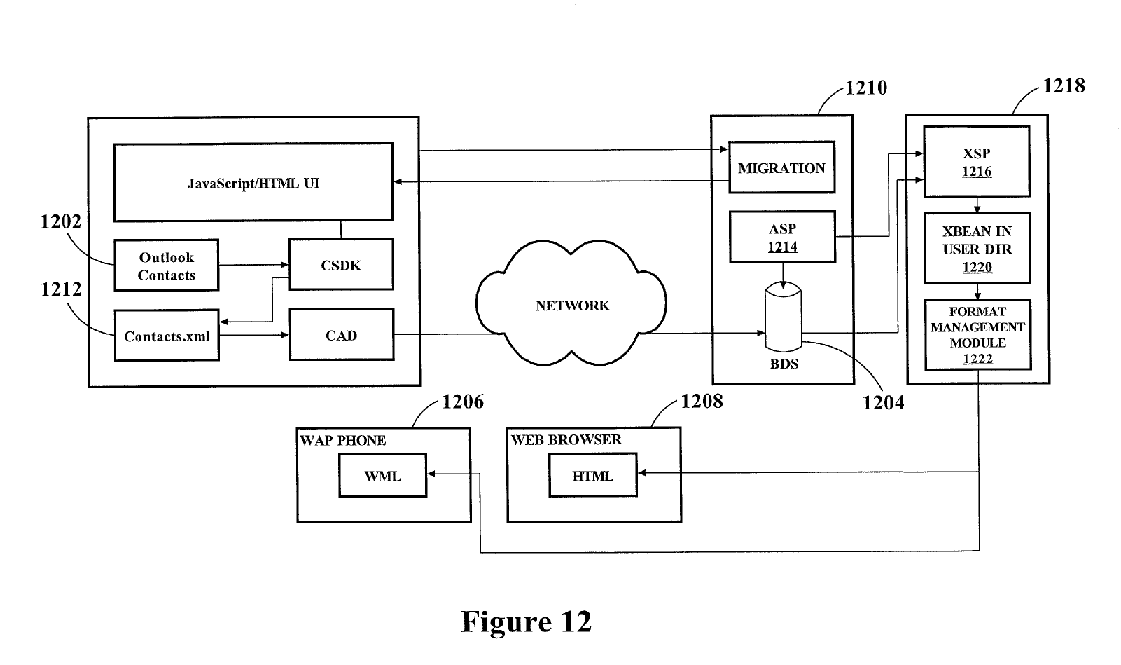

FIG. 12 illustrates another embodiment of the present invention in which WAP phone 1206, or optionally a Web browser 1208, accesses Microsoft Outlook® contacts 1202, stored in BDS 1204. First, a user logs into a first server module 1210 (containing the BDS 1204) and decides to export the contacts available in Microsoft Outlook®. Next, the user selects the contacts 1202 that need to be exported, and the system creates an XML file 1212 with all the selected contacts. The user then returns to the migration process involving other settings, files, and other data. Next, the contacts XML file is zipped and uploaded along with other data onto BDS 1204. ASP 1214 is then initialized on the server to send profile identification to XSP 1216 on second server module 1218. XSP 1216 on second server module 1218 uses the profile identification to transfer the profile from BDS 1204. Next, XSP 1216 unzips the contacts file and converts the XML file to XBean data 1220, and saves it to a user directory. Finally, a user with WAP phone 1206 or web browser 1208 logs into second server module 1218 and accesses the data in the proper format (WML or HTML) made available via the format management module 1222. Once the data is received in the proper format (WML or HTML), the receiver (phone or browser) installs the necessary settings, files, and other data in their corresponding locations to initiate a new operating environment. In a further embodiment, users are given the option to revert back to the operating environment previously held by the receiver (phone or browser) if they are not satisfied with the newly installed profile.

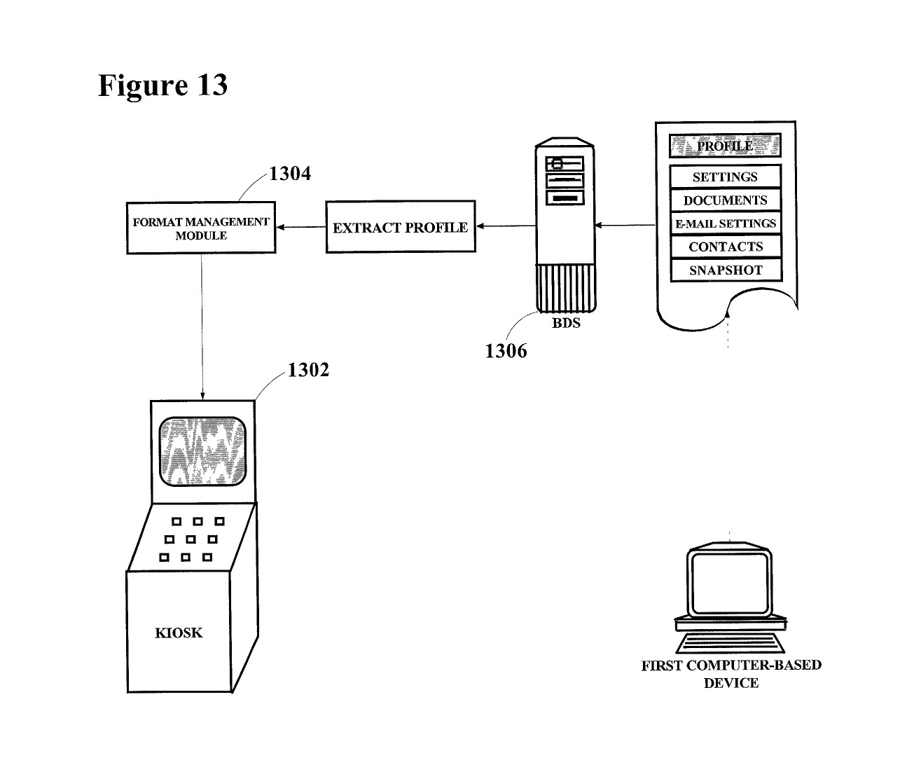

FIG. 13 illustrates another embodiment of the present invention wherein a profile is accessed via a kiosk. The upload process is essentially the same as in earlier embodiments. In the download process, a user at kiosk 1302 is able to access a formatted profile via a format management module 1304, that converts the directive file (with profile information) stored in BDS 1306 into a format compatible with the computing system of kiosk 1302. Thus, when users at kiosk 1302 request their van, the current (default) settings associated with the kiosk is first uploaded to the BDS. Next, the requested van is downloaded (and installed) in a format compatible with kiosk 1302. After users are finished using kiosk 1302, the stored van settings corresponding to the default settings (of kiosk 1302) are downloaded from the BDS and installed onto kiosk 1302.

Thus, as illustrated in the previous figures and embodiments, the present invention provides a format management method and system for transferring and converting a first group of application settings, files and other data, of a first specific format, to a second related format with respect to a receiving computer-based device, so that the receiving computer-based device will have a substantially similar operating environment to that associated with the first group.

The above described invention and its described functional elements are implemented in various computing environments. For example, the present invention may be implemented on a conventional IBM PC or equivalent, multi-nodal system (e.g. LAN) or networking system (e.g. Internet, WWW, wireless web). All programming, GUIs, display panels and dialog box templates, and data related thereto are stored in computer-based device memory, static or dynamic, and maybe retrieved by the user in any of: conventional computer-based device storage, display (i.e. CRT) and/or hardcopy (i.e. printed) formats. The programming of the present invention may be implemented by one of skill in the art of graphics or object-oriented programming.

It should be noted that the main toolsets used for development and construction of a production present invention system are, but not limited to (functionally equivalent programs can be interchanged or added without departing from the scope of the present invention as the exact hardware needs will vary as load testing indicates the capacity of each module. Another consideration is forecasting of the customer base growth rate.):

Visual Basic® 6.0 SP3 for creating the administrative and management tools

Visual C++® 6.0 SP3 for creating the CAD

Visual InterDev® 6.0 SP3 for creating the ASP files used by the Web Application Servers

Visual SourceSafe ® 6.0 SP3 for source and version control

Crystal Reports® 7 MR1 for creating reports

### Conclusion

A system and method has been shown in the above embodiments for the effective implementation of format management in a system for transporting application settings, files and other data from one computer-based device to another computer-based device. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program (e.g., ActiveX ATL control), computing environment, specific computing hardware or GUI templates.

We claim:

1. A format management method for transferring and converting, over a network, a profile of a first specific format, to a second related format with respect to a receiving computer-based device, so that the receiving computer-based device will have a substantially similar operating environment to that associated with said profile, said method comprising:
a. downloading a software module onto said receiving computer-based device;
b. identifying via said software module a first directive file, comprising a profile of a first specific format, located on a remote storage device, said first profile comprising application settings, files, and other data;
c. checking if said recipient computer's platform supports said first specific format associated with said first directive file, and if said recipient computer requires a second related format;
d. converting said first directive file of said first specific format to a second directive file of said second related format compatible with said receiving computer-based device;
e. receiving said second directive file of second related format, compatible with said receiving computer-based device, from said storage device to said receiving computer-based device, and
said second directive file of second related format comprising of application settings, files, and other data is installed on said receiving computer-based device such that said receiving device has a substantially similar operating environment to that associated with said stored profile.

2. A format management method for transferring and converting, over a network, a profile of a first specific format, to a second related format with respect to a receiving computer-based device, as per claim 1, wherein said step of converting further comprises:
identifying a format associated with said computer-based device requesting said directive file;
parsing said directive file associated with said requesting computer-based device to extract markup data;
identifying a stylesheet, corresponding to said identified format;
applying said identified stylesheet to said markup data from said parsed directive file;
rendering said markup data, along with said applied stylesheet, in said identified format compatible with said receiving computer-based device.

3. A format management method for transferring and converting, over a network, a profile of a first specific format, to a second related format with respect to a receiving computer-based device, as per claim 1, wherein said network is any of the following: HTTP-based, Internet, wide area networks (WANs), local area networks (LANs), virtual LANs, wireless, web, or telecommunication based.

4. A format management method for transferring and converting, over a network, a profile of a first specific format, to a second related format with respect to a receiving computer-based device, as per claim 1, wherein said receiving computer is any of the following: personal computer systems, laptops, portable computers, web and WAP phones.

5. A format management method for transferring and converting, over a network, a profile of a first specific format, to a second related format with respect to a receiving computer-based device, as per claim 1, wherein said markup language is any of the following: XML, SGML, or HTML.

6. A format management method for transferring and converting, over a network, a profile of a first specific format, to a second related format with respect to a receiving computer-based device, as per claim 1, wherein said network is an enterprise network and said remote storage device is an enterprise server.

7. A format management method for transferring and converting, over a network, a profile of a first specific format, to a second related format with respect to a receiving computer-based device, as per claim 1, wherein said settings comprise any of the following: hardware settings, system settings, attached device settings, application settings, document settings, desktop settings, e-mail settings, addressbook settings, bookmarks, or cookies.

8. A format management method for transferring and converting, over a network, a profile of a first specific format, to a second related format with respect to a receiving computer-based device, as per claim 1, wherein said software module is written in an object-oriented higher level language.

9. A format management method for transferring and converting, over a network, a profile of a first specific format, to a second related format with respect to a receiving computer-based device, as per claim 1, wherein said software module further includes ActiveX support.

10. A format management method for transferring and converting, over a network, a profile of a first specific format, to a second related format with respect to a receiving computer-based device, so that the receiving computer-based device will have a substantially similar operating environment to that associated with said profile, said method comprising:
a. downloading a software module onto a first computer-based device;
b. identifying, via said software module, a profile of a first specific format located on said first computer-based device, said profile comprising applications settings, files, and other data;
c. creating a first markup file comprising said identified profile;
d. transferring said first markup file onto a remote storage device;
e. downloading a software module onto a receiving computer-based system associated with a second specific format;
f. identifying, via said software module, said first directive file with said identified profile of said first specific format located on said remote storage device;
g. comparing said first specific format to said second specific format, and if said compared formats are different;
h. converting said first directive file of said first specific format to a second directive file of said second related format compatible with said receiving computer-based device;
i. transferring said second directive profile to said receiving computer-based device, and
j. installing said second directive file on said receiving computer-based device such that said receiving device has a substantially similar operating environment to that associated with said first computer-based device.

11. A format management method for transferring and converting, over a network, a profile of a first specific format, to a second related format with respect to a receiving computer-based device, as per claim 10, wherein said step of converting further comprises:
identifying a format associated with said computer-based device requesting said profile;
parsing said first directive file associated with said requesting computer-based device to extract markup data;
identifying a stylesheet, corresponding to said identified format;
applying said identified stylesheet to said markup data from said parsed first directive file;
rendering said markup data, along with said applied stylesheet, in said identified format compatible with said receiving computer-based device.

12. A format management method for transferring and converting, over a network, a profile of a first specific format, to a second related format with respect to a receiving computer-based device, as per claim 10, wherein said network is any of the following: HTTP-based, Internet, wide area networks (WANs), local area networks (LANs), virtual LANs, wireless, web, or telecommunication based.

13. A format management method for transferring and converting, over a network, a profile of a first specific format, to a second related format with respect to a receiving computer-based device, as per claim 10, wherein said receiving computer is any of the following: personal computer systems, laptops, portable computers, web and WAP phones.

14. A format management method for transferring and converting, over a network, a profile of a first specific format, to a second related format with respect to a receiving computer-based device, as per claim 10, wherein said markup language is any of the following: XML, SGML, or HTML.

15. A format management method for transferring and converting, over a network, a profile of a first specific format, to a second related format with respect to a receiving computer-based device, as per claim 10, wherein said network is an enterprise network and said remote storage device is an enterprise server.

16. A format management method for transferring and converting, over a network, a profile of a first specific format, to a second related format with respect to a receiving computer-based device, as per claim 10, wherein said settings comprise any of the following: hardware settings, system settings, attached device settings, application settings, document settings, desktop settings, e-mail settings, addressbook settings, bookmarks, or cookies.

17. A format management method for transferring and converting, over a network, a profile of a first specific format, to a second related format with respect to a receiving computer-based device, as per claim 10, wherein said software module is written in an object-oriented higher level language.

18. A format management method for transferring and converting, over a network, a profile of a first specific format, to a second related format with respect to a receiving computer-based device, as per claim 10, wherein said software module further includes ActiveX support.

19. A format management system for converting and transferring, over a network, a profile of a first specific format, comprising computer-based settings, files, and other data, to a second related format with respect to a receiving computer-based device, so that the receiving computer-based device will have a substantially similar operating environment to that associated with the first profile, said system comprising:
a. a network server, said network server operatively connect to one or more remote computer-based devices, said network server receiving at least one request for a specific profile from said one or more remote computer-based devices;
b. a software module, operable with said network server, determining a format of said at least one requestor;
c. a first set of one or more mark-up based directive(s), located in said network server, said directive(s) associated with said specific profile;
d. a format management module converting said first set of directives to a format compatible with said determined format, and
said software module parsing said converted directives and installing said settings, files, and other data to provide a new operating environment for the receiving computer-based device.

20. A format management system for transferring and converting, over a network, a first profile of a first specific format, to a second related format with respect to a receiving computer-based device, as per claim 19, wherein said format management module further comprises of:
a markup language publisher;
a markup language parser;
a stylesheet processor, and
wherein said markup language publisher identifies a format associated with said receiving computer-based device requesting said directive file, calls said markup language parser to parse the content of said directive file, and calls said stylesheet processor to apply a stylesheet corresponding to said identified format to output markup data in said format compatible with said receiving computer-based device.

21. A format management system for transferring and converting, over a network, a first profile of a first specific format, to a second related format with respect to a receiving computer-based device, as per claim 19, wherein said network is any of the following: HTTP-based, Internet, wide area networks (WANs), local area networks (LANs), virtual LANs, wireless, web, or telecommunication based.

22. A format management system for transferring and converting, over a network, a first profile of a first specific format, to a second related format with respect to a receiving computer-based device, as per claim 19, wherein said receiving computer is any of the following: personal computer systems, laptops, portable computers, web and WAP phones.

23. A format management system for transferring and converting, over a network, a first profile of a first specific format, to a second related format with respect to a receiving computer-based device, as per claim 19, wherein said markup language is any of the following: XML, SGML, or HTML.

24. A format management system for transferring and converting, over a network, a first profile of a first specific format, to a second related format with respect to a receiving computer-based device, as per claim 19, wherein said network is an enterprise network and said remote storage device is an enterprise server.

25. A format management system for transferring and converting, over a network, a first profile of a first specific format, to a second related format with respect to a receiving computer-based device, as per claim 19, wherein said settings comprise any of the following: hardware settings, system settings, attached device settings, application settings, document settings, desktop settings, e-mail settings, addressbook settings, bookmarks, or cookies.

26. A format management system for transferring and converting, over a network, a first profile of a first specific format, to a second related format with respect to a receiving computer-based device, as per claim 19, wherein said software module is written in an object-oriented higher level language.

27. A format management system for transferring and converting, over a network, a first profile of a first specific format, to a second related format with respect to a receiving computer-based device, as per claim 19, wherein said software module further includes ActiveX support.

28. A format management method for transferring and converting, over a network, a profile of a first specific format, to a related format with respect to a computer-based device requesting said profile, so that the requesting computer-based device will have a substantially similar operating environment to that associated with said profile, said method comprising:
a. receiving a request for a profile comprising settings, files, and other data from a computer-based device;
b. identifying a format compatible with said requesting computer-based device;
c. extracting a first directive file representative of said identified format;
d. parsing said first directive file to extract markup data;
e. identifying a stylesheet corresponding to said identified format;
f. rendering said markup data with said stylesheet in said format compatible with said computer-based device;
g. transporting said rendered data to said requesting computer-based device, and
h. parsing rendered data to extract said profile, and installing said settings, files, and
other data in corresponding locations, such that the requesting computer-based device has a similar computing environment to that associated with said extracted first directive file.

29. A format management method for transferring and converting, over a network, a profile of a first specific format, to a related format with respect to a computer-based device requesting said profile, as per claim 28, wherein said rendered data is encapsulated in a second directive file.

30. A format management method for transferring and converting, over a network, a profile of a first specific format, to a related format with respect to a computer-based device requesting said profile, as per claim 28, wherein said requesting computer-based device is any of the following: personal computer systems, laptops, portable computers, printer systems, facsimile systems, web or WAP phones.

31. A format management method for transferring and converting, over a network, a profile of a first specific format, to a related format with respect to a computer-based device requesting said profile, as per claim 28, wherein said directive files are in any of the following markup language formats: XML, SGML, HTML, or WML.

32. A format management method for transferring and converting, over a network, a profile of a first specific format, to a related format with respect to a computer-based device requesting said profile, as per claim 29, wherein said directive files are in any of the following markup language formats: XML, SGML, HTML, or WML.

33. A format management method for transferring and converting, over a network, a profile of a first specific format, to a related format with respect to a computer-based device requesting said profile, as per claim 28, wherein said network is any of the following: HTTP-based, Internet, WANs, LANS, virtual LANS, wireless, web, or telecommunication based.

34. A format management method for transferring and converting, over a network, a profile of a first specific format, to a related format with respect to a computer-based device requesting said profile, as per claim 28, wherein said step of transporting said rendered data is accomplished via JavaBeans.

35. A format management method for transferring and converting, over a network, a profile of a first specific format, to a related format with respect to a computer-based device requesting said profile, as per claim 28, wherein said stylesheet is in an XSL format.

36. A format management method for transferring and converting, over a network, a profile of a first specific format, to a related format with respect to a computer-based device requesting said profile, as per claim 28, wherein said settings comprise any of the following: hardware settings, system settings, attached device settings, application settings, document settings, desktop settings, e-mail settings, addressbook settings, bookmarks, or cookies.

37. A format management method for transferring and converting, over a network, a profile of a first specific format, to a related format with respect to a computer-based device requesting said profile, as per claim 28, wherein said step of transporting rendered data is accomplished via the simple object access protocol (SOAP).

38. A format management method for transferring and converting, over a network, a profile of a first specific format, to a related format with respect to a computer-based device requesting said profile, as per claim 28, wherein said network is an enterprise network and said remote storage device is an enterprise server.

39. A format management method for transferring and converting, over a network, a profile of a first specific format, to a related format with respect to a computer-based device requesting said profile, as per claim 28, wherein said method further comprises the step of caching the rendered data for future access by said requesting computer-based device.

40. A format management method for transferring and converting, over a network, a profile comprising settings, files, and other data of a first specific format, to a related format with respect to a telephone requesting said profile, so that the requesting telephone will have a substantially similar operating environment to that associated with said profile, said method comprising:
a. receiving a request for a profile comprising settings, files, and other data from a telephone;
b. identifying a format compatible with said requesting telephone;
c. extracting a first directive file representative of said identified format compatible with said requesting telephone;
d. parsing said first directive file to extract markup data;
e. identifying a stylesheet corresponding to said identified format;
f. rendering said markup data with said stylesheet in said format compatible with said telephone;
g. transporting said rendered data to said requesting telephone, and
h. parsing rendered data to extract said profile, and installing said settings, files, and other data in corresponding locations, such that said requesting telephone has a similar computing environment to that associated with said extracted first directive file.

41. A format management method for transferring and converting, over a network, a profile comprising settings, files, and other data of a first specific format, to a related format with respect to a telephone requesting said profile, as per claim 40, wherein said rendered data is encapsulated in a second directive file.

42. A format management method for transferring and converting, over a network, a profile comprising settings, files, and other data of a first specific format, to a related format with respect to a telephone requesting said profile, as per claim 40, wherein said requesting telephone is any of the following: portable telephones, cellular phones, web or WAP phones.

43. A form at management method for transferring and converting, over a network, a profile comprising settings, files, and other data of a first specific format, to a related format with respect to a telephone requesting said profile, as per claim 40, wherein said directive files are in any of the following markup language formats: XML, SGML, HTML, or WML.

44. A format management method for transferring and converting, over a network, a profile comprising settings, files, and other data of a first specific format, to a related format with respect to a telephone requesting said profile, as per claim 41, wherein said directive files are in any of the following markup language formats: XML, SGML, HTML, or WML

45. A format management method for transferring and converting, over a network, a profile comprising settings, files, and other data of a first specific format, to a related format with respect to a telephone requesting said profile, as per claim 40, wherein said network is any of the following: HTTP-based, Internet, WANs, LANs, virtual LANs, wireless, web, or telecommunication based.

46. A format management method for transferring and converting, over a network, a profile comprising settings, files, and other data of a first specific format, to a related format with respect to a telephone requesting said profile, as per claim 40, wherein said step of transporting said rendered data is accomplished via JavaBeans.

47. A format management method for transferring and converting, over a network, a profile comprising settings, files, and other data of a first specific format, to a related format with respect to a telephone requesting said profile, as per claim 40, wherein said stylesheet is in an XSL format.

48. A format management method for transferring and converting, over a network, a profile comprising settings, files, and other data of a first specific format, to a related format with respect to a telephone requesting said profile, as per claim 40, wherein said settings comprise any of the following: hardware settings, system settings, attached device settings, application settings, document settings, desktop settings, e-mail settings, addressbook settings, bookmarks, or cookies.

49. A format management method for transferring and converting, over a network, a profile comprising settings, files, and other data of a first specific format, to a related format with respect to a telephone requesting said profile, as per claim 40, wherein said step of transporting rendered data is accomplished via the simple object access protocol (SOAP).

50. A format management method for transferring and converting, over a network, a profile comprising settings, files, and other data of a first specific format, to a related format with respect to a telephone requesting said profile, as per claim 40, wherein said network is a enterprise network and said remote storage device is a enterprise server.

51. A format management method for transferring and converting, over a network, a profile comprising settings, files, and other data of a first specific format, to a related format with respect to a telephone requesting said profile, as per claim 40, wherein said method further comprises the step of caching the rendered data for future access by requesting telephone.
